(19) United States
(12) Patent Application Publication
(10) Pub. No.: US 2025/0003836 A1
(43) Pub. Date: Jan. 2, 2025

(54) METHOD FOR MONITORING CONFIGURATION OF AN AIRCRAFT ENGINE AND ASSOCIATED SYSTEM

(71) Applicant: SAFRAN AIRCRAFT ENGINES, PARIS (FR)

(72) Inventors: Tony Alain Roger Joël LHOMMEAU, MOISSY CRAMAYEL (FR); Alméric Pierre Louis GARNIER, MOISSY CRAMAYEL (FR)

(21) Appl. No.: 18/708,927

(22) PCT Filed: Nov. 9, 2022
(86) PCT No.: PCT/EP2022/081347

§ 371 Date: Jun. 4, 2024

(30) Foreign Application Priority Data
Nov. 10, 2021 (FR) 2111912

(51) Int. Cl. G01M 15/14; B64F 5/60; G06Q 10/20

(52) U.S. Cl. CPC G01M 15/14; G06Q 10/20; B64F 5/60

(57) ABSTRACT

A method for monitoring configuration of an aircraft engine including a plurality of pieces of equipment each having a radio identification device, associated with a reference configuration including a set of reference identification data per piece of equipment, including automatically reading each radio identification device to obtain a configuration including at least one set of identification data read per piece of equipment; for each piece of equipment for which the set of identification data read is different from the set of reference identification data: if the set of identification data read corresponds to a set of replacement identification data associated with an operation for replacing the piece of equipment, replacing the set of reference identification data by the set of identification data read; otherwise, generating an alert.

### TECHNICAL FIELD OF THE INVENTION

The technical field of the invention is that of aircraft engines and more particularly that of monitoring configuration of aircraft engines.

The present invention relates to a method for monitoring configuration of an aircraft engine. The present invention also relates to a system for monitoring configuration of an aircraft engine, a computer program product and a recording medium.

### TECHNOLOGICAL BACKGROUND OF THE INVENTION

In order to be authorised to fly an aircraft, an airline needs to know the configuration of each engine in the aircraft, that is, the list including the unique set of identification data, comprising for example the Serial Number and Part Number respectively, of each piece of equipment fitted to the engine.

Since a discrepancy between the certified configuration and the actual configuration of the engine is considered to be the responsibility of the operator, the inventory operations for knowing the configuration of an engine are carried out by a human operator who identifies himself/herself and signs the inventory. As the inventory is carried out manually, the operation is therefore long and tedious.

To remedy this drawback, it is known to place an RFID tag on each piece of equipment of the engine and to carry out an automatic reading to automatically generate an inventory of the engine. It is then possible to know the configuration of the engine in real time and therefore to know its changes over time better, which is especially interesting for planning engine inspection and maintenance operations.

However, the information provided by automatic reading may be erroneous, for example if an RFID tag of a piece of equipment removed from the engine has fallen into the engine or in the case where a piece of equipment fitted with an RFID tag is located in proximity to the engine during automatic reading. Validation by a human operator is therefore necessary to comply with the regulations, which considerably limits the advantages of using an automatic inventory.

There is therefore a need to reliably know the configuration of an aircraft engine while reducing the time required to carry out the engine inventory.

### SUMMARY OF THE INVENTION

The invention provides a solution to the problems discussed previously, by making it possible to reliably monitor configuration of an aircraft engine while limiting the number of steps requiring the intervention of a human operator.

A first aspect of the invention relates to a method for monitoring configuration of an aircraft engine comprising a plurality of pieces of equipment, each piece of equipment having a radio identification device, the engine being associated with a reference configuration comprising a date of last update and, for each piece of equipment, a set of reference identification data of the piece of equipment, the method comprising the following steps of:
automatically reading each radio identification device to obtain a configuration comprising at least one set of identification data read for each piece of equipment and a date of execution;
for each piece of equipment, comparing the set of identification data read and the set of reference identification data corresponding to the piece of equipment:
   if, for each piece of equipment, the set of identification data read is identical to the set of reference identification data, replacing the date of last update of the reference configuration by the date of execution of the configuration obtained;
   otherwise, for each piece of equipment for which the set of identification data read is different from the set of reference identification data:
      if an operation for replacing the piece of equipment has taken place between the date of last update and the date of execution and the set of identification data read corresponds to a set of replacement identification data associated with the replacement operation, replacing the set of reference identification data by the set of identification data read;
      otherwise, generating an alert;
if at least one set of reference identification data has been replaced, replacing the date of last update of the reference configuration by the execution date of the configuration obtained.

By virtue of the invention, an inventory of an aircraft engine is automatically carried out using radio identification devices installed on the pieces of equipment of the engine, to obtain a configuration of the engine.

The configuration obtained is then compared with a reference configuration of the engine corresponding to a recent certified configuration for the engine, that is, a recent configuration validated by a human operator for the engine.

If a discrepancy is noticed between the configuration obtained and the reference configuration, that is, if there is a piece of equipment for which the set of identification data read obtained by reading the corresponding identification device is different from the set of identification data associated with the piece of equipment in the reference configuration, the list of replacement operations having taken place between the date associated with the reference configuration and the date associated with the configuration obtained for the piece of equipment is referred to. Each replacement operation is certified and associated with a set of identification data for the piece of equipment fitted during the replacement operation.

If the set of identification data read for the piece of equipment corresponds to the set of identification data of the piece of equipment fitted during a replacement operation included in the list, the discrepancy is considered justified and the reference configuration is updated with the set of identification data read for the piece of equipment.

If the discrepancy cannot be explained by a replacement operation, it is considered unjustified and an alert is issued.

Thus, a human operator will only intervene in the inventory operation of the engine if there is a discrepancy not justified by a certified replacement operation, between the configuration obtained automatically by radio identification and the certified reference configuration. The number of human interventions is therefore considerably reduced without reducing reliability of the configuration obtained, since the latter is verified by only taking account of certified data.

In addition to the characteristics just discussed in the previous paragraph, the method according to the invention may have one or more additional characteristics from among the following, considered individually or according to any technically possible combinations.

According to an alternative embodiment, the reference configuration is stored in a configuration database, the method according to the invention further comprising a step of storing the configuration obtained in a buffer database independent of the configuration database.

Thus, the uncertified data of the configuration obtained are not mixed with the certified data of the reference configuration, which avoids security problems.

According to a sub-alternative embodiment of the previous alternative embodiment, the method according to the invention further comprises a step of deleting the configuration obtained from the buffer database.

Thus, the uncertified data of the configuration obtained are not kept.

A second aspect of the invention relates to a system for monitoring configuration of an aircraft engine comprising a plurality of pieces of equipment, each piece of equipment having a radio identification device, the system comprising:
a radio reading module configured to automatically read, for each piece of equipment, the corresponding radio identification device to obtain a set of identification data read for the piece of equipment;
a configuration database configured to store a reference configuration associated with the engine, the reference configuration comprising a date of last update and for each piece of equipment, a set of reference identification data of the piece of equipment;
a buffer database configured to store a configuration comprising a date of execution and each set of identification data read obtained using the radio reading module, the buffer database being independent of the configuration database;
a processing module configured to, for each piece of equipment, compare the set of identification data read and the set of reference identification data corresponding to the piece of equipment:
   if, for each piece of equipment, the set of identification data read is identical to the set of reference identification data, replace the date of last update of the reference configuration by the date of execution of the configuration;
   otherwise, for each piece of equipment for which the set of identification data read is different from the set of reference identification data:
      if an operation for replacing the piece of equipment has taken place between the date of last update and the date of execution and the set of identification data read corresponds to a set of replacement identification data associated with the replacement operation, replace the set of reference identification data by the set of identification data read;
      otherwise, generate an alert;
   if at least one set of reference identification data has been replaced, replace the date of last update of the reference configuration by the date of execution of the configuration.

According to an alternative embodiment, the configuration database is encrypted and/or has authentication access control.

Thus, the configuration database comprising certified data is secure.

According to an alternative embodiment compatible with the previous alternative embodiment, the system according to the invention comprises a telecommunications network configured to allow message exchanges between the radio reading module and the buffer database, and between the processing module, the configuration database and the buffer database, via a communication protocol.

According to a sub-alternative embodiment of the previous alternative embodiment, the communication protocol is end-to-end encrypted.

Thus, communications between the different elements of the system according to the invention are secure.

According to a sub-alternative embodiment of the previous alternative embodiment compatible with the previous sub-alternative embodiment, the telecommunications network comprises at least one telecommunications node, each telecommunications node storing a synchronised copy of a self-executing contract configured to verify the validity of messages transmitted within the telecommunications network.

Thus, consensus on each transmitted message is ensured.

A third aspect of the invention relates to a computer program product comprising instructions which, when the program is executed on a computer, cause the same to implement the steps of the method according to the invention.

A fourth aspect of the invention relates to a computer-readable recording medium comprising instructions which, when executed by a computer, cause the same to implement the steps of the method according to the invention.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 is a block diagram illustrating the sequence of steps in a method according to the invention.

FIG. 2 shows a schematic representation of a system according to the invention.

### DETAILED DESCRIPTION

Unless otherwise specified, a same element appearing in different figures has a single reference.

A first aspect of the invention relates to a method for monitoring configuration of an aircraft engine to which a plurality of pieces of equipment is fitted.

By ‘configuration of an engine’, it is meant the list including a unique set of identification data for each piece of equipment fitted to the engine. The set of identification data of a piece of equipment includes, for example, its serial number, part number, production number, manufacturer and/or date of manufacture.

FIG. 2 shows a schematic representation of an aircraft engine 300.

In FIG. 2, the aircraft is an aeroplane including two engines 300 to which a plurality of pieces of equipment 301 is fitted.

The engine 300 is associated with a reference configuration corresponding to the configuration obtained during a previous inventory operation of the engine 300.

The reference configuration includes a date of last update corresponding, for example, to the date of execution of the previous inventory operation and a set of reference identification data for each piece of equipment 301 of the engine 300.

The reference configuration has, for example, been certified by a human operator.

The reference configuration is for example stored in a configuration database 201.

Each piece of equipment 301 of the engine 300 has a radio identification device 3010.

The radio-identification device 3010 is, for example, a chip or a radio-identification (or RFID) tag.

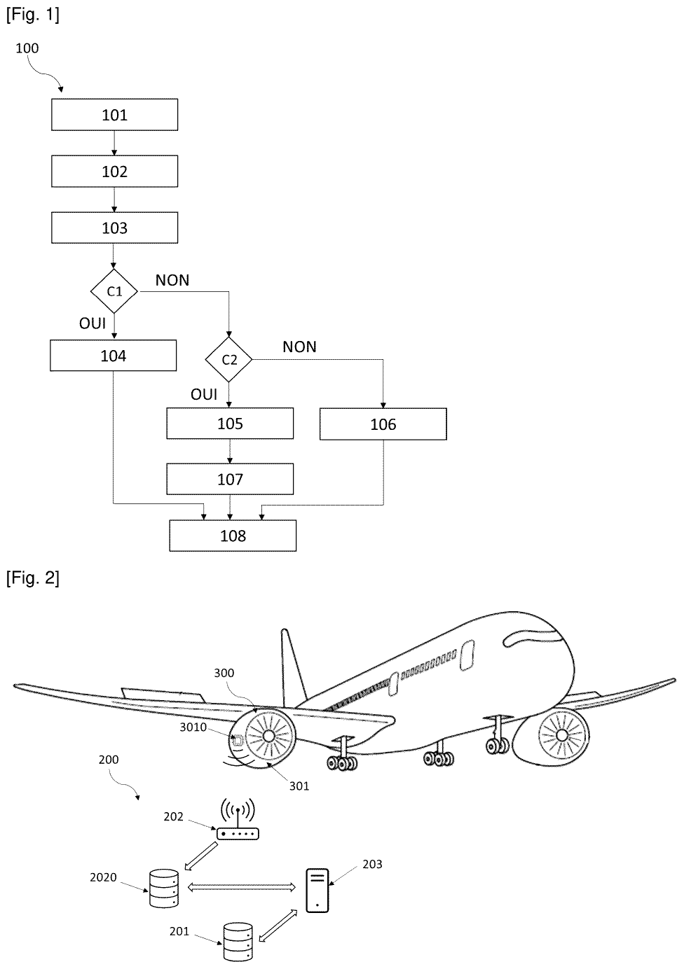

FIG. 1 is a block diagram illustrating the sequence of steps in the method 100 according to the invention.

A first step 101 of the method 100 according to the invention consists in obtaining a configuration by automatically reading each radio identification device 3010 of the engine 300.

The configuration comprises each set of identification data obtained by reading the corresponding radio identification device 3010, and thus at least one set of identification data read for each piece of equipment 301 of the engine 300.

In the nominal case, a piece of equipment 301 of the engine 300 is associated with a single set of identification data in the configuration.

A piece of equipment 301 of the engine 300 may however be associated with a plurality of sets of identification data, for example in the case where a radio identification device 3010 of a previous version of the piece of equipment now removed from the engine 300 has fallen into the engine 300.

The configuration also comprises a date of execution corresponding, for example, to the date of execution of the automatic reading.

The method 100 according to the invention may include a second step 102 consisting in storing the configuration obtained in the first step 101 in a buffer database 2020.

The buffer database 2020 is then independent of the configuration database 201 in which the reference configuration associated with the engine 300 is stored.

A third step 103 of the method 100 according to the invention consists, for each piece of equipment 301 of the engine 300, in comparing the set of identification data read obtained in the first step 101 for the piece of equipment 301 and the set of reference identification data corresponding to the piece of equipment 301 in the reference configuration.

If a first condition C1 is satisfied, a fourth step 104 of the method 100 according to the invention is carried out.

The first condition C1 is satisfied if, for each piece of equipment 301 of the engine 300, the set of identification data read obtained in the first step 101 for the piece of equipment 301 is identical to the set of reference identification data corresponding to the piece of equipment 301 in the reference configuration.

The fourth step 104 of the method 100 according to the invention consists in replacing the date of last update of the reference configuration by the date of execution of the configuration obtained in the first step 101.

The first condition C1 is not satisfied if there is at least one piece of equipment 301 of the engine 300 for which the set of identification data read obtained in the first step 101 for the piece of equipment 301 is different from the set of reference identification data corresponding to the piece of equipment 301 in the reference configuration.

This is especially the case if a piece of equipment 301 of the engine 300 is associated with a plurality of sets of identification data in the configuration obtained in the first step 101.

For each equipment 301 of the engine 300 for which the set of identification data read obtained in the first step 101 for the piece of equipment 301 is different from the set of reference identification data corresponding to the piece of equipment 301 in the reference configuration, a fifth step 105 of the method 100 according to the invention is carried out if a second condition C2 is satisfied for the piece of equipment 301.

The second condition C2 is satisfied for the piece of equipment 301 if an operation for replacing the piece of equipment 301 has taken place between the date of last update included in the reference configuration and the date of execution of the configuration obtained in the first step 101, and the set of identification data read obtained in the first step 101 for the piece of equipment 301 corresponds to a set of replacement identification data associated with the replacement operation.

By ‘operation for replacing a piece of equipment’, it is meant an operation consisting in replacing a piece of equipment installed on the engine by a new piece of equipment.

The set of replacement identification data associated with the replacement operation then corresponds, for example, to the set of identification data for the new piece of equipment.

Such a replacement operation is certified by a human operator and has, for example, occurred within the scope of a service request or a maintenance request.

The fifth step 105 of the method 100 according to the invention consists in replacing the set of reference identification data corresponding to the piece of equipment 301 in the reference configuration by the set of identification data read obtained in the first step 101 for the piece of equipment 301.

If the second condition C2 is not satisfied for the piece of equipment 301, that is, if no operation for replacing the piece of equipment 301 has taken place between the date of last update included in the reference configuration and the date of execution of the configuration obtained in the first step 101, or if an operation for replacing the piece of equipment 301 has taken place between the date of last update and the date of execution but the set of identification data read obtained in the first step 101 for the piece of equipment 301 does not correspond to the set of replacement identification data associated with the replacement operation, a sixth step 106 of the method 100 according to the invention is carried out.

The sixth step 106 consists in generating an alert.

Generating an alert may, for example, involve an inventory operation, that is, a verification of the configuration of the engine 300, by a human operator as in prior art.

The method 100 according to the invention includes a seventh step 107 if at least one set of reference identification data has been replaced in the reference configuration, that is, if the fifth step 105 has been carried out for at least one piece of equipment 301 of the engine 300.

The seventh step 107 consists in replacing the date of last update of the reference configuration by the date of execution of the configuration obtained in the first step 101.

In the case where the method 100 according to the invention includes the second step 102, the method 100 according to the invention may include a final eighth step 108 consisting in deleting the configuration obtained in the first step 101 from the buffer database 2020.

A second aspect of the invention relates to a system 200 for monitoring configuration of the engine 300 adapted to the implementation of the method 100 according to the invention.

As illustrated in FIG. 2, the system 200 according to the invention includes:
the configuration database 201;
the buffer database 2020;
a radio reading module 202 configured to implement the first step 101 of the method 100 according to the invention;
a processing module 203 configured to implement all the steps of the method 100 according to the invention except the first step 101.

The processing module 203 includes, for example, at least one processor and one memory.

The configuration database 201 further stores, for example, a history of the configurations of the engine 300, that is, all the pieces of equipment that have been fitted to the engine 300.

The configuration database 201 is for example encrypted, for example by strong encryption, for example by AES-256 bit encryption.

The configuration database 201 has, for example, authentication access control.

The configuration database 201 and the buffer database 2020 may be two separate databases as represented in FIG. 2, or two independent parts of a same database.

The buffer database 2020 may, for example, be included in the radio reading module 202.

The system 200 according to the invention further includes a telecommunications network configured to ensure communications within the system 200, that is, to enable messages exchanges within the system 200. For this, the telecommunications network uses a communication protocol.

As illustrated in FIG. 2, the telecommunications network makes it possible, for example, to ensure communication between the radio reading module 202 and the buffer database 2020, communication between the processing module 203 and the buffer database 2020 and communication between the processing module 203 and the configuration database 201.

The telecommunications network may be a wired network or a wireless network.

The telecommunications network may be the Internet and may include a cloud.

The configuration database 201 may be hosted in the cloud.

The communication protocol is for example end-to-end encrypted, for example with double authentication keys.

The messages exchanged are for example transmitted in the form of frames. Each frame includes, for example, in addition to the message content, recipient address information including, for example, a public key, the communication standard used, a message identifier, a time stamp, and a verifiable electronic signature of the sender generated, for example, by a private key.

Each frame may be encrypted, for example in the form of a hash code, for example via a Merkel tree.

The communication protocol may implement a consensus method, for example by third party notary and trusted third party, by proof of stakes or by proof of work.

The communication protocol ensures, for example, the distribution, synchronisation, replication and verification of messages transmitted within the telecommunications network so that the transmission of messages is transactional and non-repudiable.

The telecommunications network comprises at least one telecommunications node.

Each telecommunications node may be hosted within the system 200 according to the invention, for example behind firewalls or on the radio reading module 202, or on the cloud.

Each telecommunications node stores, for example, a synchronised copy of a self-executing contract, otherwise known as a ‘smart contract’, shared by the telecommunications network.

The self-executing contract is configured, for example, to verify the validity of messages transmitted within the telecommunications network, that is, to verify their conformity in order to reach a consensus.

1. A method for monitoring configuration of an aircraft engine comprising a plurality of pieces of equipment, each piece of equipment having a radio identification device, the method comprising a step of automatically reading each radio identification device to obtain a configuration comprising at least one set of identification data read for each piece of equipment and a date of execution, wherein the aircraft engine is associated with a reference configuration comprising a date of last update and, for each piece of equipment, a set of reference identification data of the piece of equipment, and the method comprising the following steps of:
for each piece of equipment, comparing the set of data read and the set of reference identification data corresponding to the piece of equipment:
if, for each piece of equipment, the set of identification data read is identical to the set of reference identification data, replacing the date of last update of the reference configuration by the date of execution of the configuration obtained;
otherwise, for each piece of equipment for which the set of identification data read is different from the set of reference identification data:
if an operation for replacing the piece of equipment has taken place between the date of last update and the date of execution and the set of identification data read corresponds to a set of replacement identification data associated with the replacement operation, replacing the set of reference identification data by the set of identification data read;
otherwise, generating an alert;
if at least one set of reference identification data has been replaced, replacing the date of last update of the reference configuration by the date of execution of the configuration obtained.

2. The method according to claim 1, wherein the reference configuration is stored in a configuration database, the method further comprising a step of storing the configuration obtained in a buffer database independent of the configuration database.

3. The method according to claim 2, further comprising a step of deleting the configuration obtained from the buffer database.

4. A system for monitoring configuration of an aircraft engine comprising a plurality of pieces of equipment, each piece of equipment having a radio identification device, the system comprising a radio reading module configured to automatically read, for each piece of equipment, the corresponding radio identification device to obtain a set of identification data read for the piece of equipment, the system comprising:
a configuration database configured to store a reference configuration associated with the engine, the reference configuration comprising a date of last update and, for each piece of equipment, a set of reference identification data of the piece of equipment;
a buffer database configured to store a configuration comprising a date of execution and each set of identification data read using the radio reading module, the buffer database being independent of the configuration database;
a processing module configured to, for each piece of equipment, compare the set of identification data read and the set of reference identification data corresponding to the piece of equipment:
if, for each piece of equipment, the set of identification data read is identical to the set of reference identification data, replace the date of last update of the reference configuration by the date of execution of the configuration;
otherwise, for each piece of equipment for which the set of identification data read is different from the set of reference identification data:
if an operation for replacing the piece of equipment has taken place between the date of last update and the date of execution and the set of identification data read corresponds to a set of replacement identification data associated with the replacement operation, replace the set of reference identification data by the set of identification data read;
otherwise, generate an alert;
if at least one set of reference identification data has been replaced, replace the date of last update of the reference configuration by the date of execution of the configuration.

5. The system according to claim 4, wherein the configuration database is encrypted and/or has authentication access control.

6. The system according to claim 4, comprising a telecommunications network configured to allow message exchanges between the radio reading module and the buffer database and between the processing module, the configuration database and the buffer database, via a communication protocol.

7. The system according to claim 6, wherein the communication protocol is end-to-end encrypted.

8. The system according to claim 6, wherein the telecommunications network comprises at least one telecommunications node, each telecommunications node storing a synchronised copy of a self-executing contract configured to verify validity of messages transmitted within the telecommunications network.

9. (canceled)

10. A non-transitory computer-readable recording medium comprising instructions which, when executed by a computer, cause the same to implement the steps of the method according to claim 1.
